(19) United States
(12) Patent Application Publication
(10) Pub. No.: US 2025/0178691 A1
(43) Pub. Date: Jun. 5, 2025

(54) BICYCLE PLATFORM

(71) Applicants: Australian Sports Commission, Bruce, ACT (AU); AusTriathlon Ltd, Surry Hills, NSW (AU)

(72) Inventors: Andrew Richardson, Bruce, ACT (AU); Justin Drew, Surry Hills, NSW (AU)

(21) Appl. No.: 18/838,772

(22) PCT Filed: Feb. 15, 2022
(86) PCT No.: PCT/AU2022/050101

§ 371 Date: Aug. 15, 2024

(51) Int. Cl. B62M 3/08; B62J 45/20; B62J 45/412; B62J 50/21

(52) U.S. Cl. CPC B62M 3/086; B62J 45/20; B62J 45/412; B62J 50/21

(57) ABSTRACT

A bicycle platform for releasably attaching a shoe to a pedal of a bicycle, the platform comprising a base having an underside and a topside, the underside being adapted to receive a cleat, the cleat being for engagement with the pedal of the bicycle, the platform further comprising a toe engagement member and a heel engagement member for selectively retaining a shoe in engagement with the platform. The toe and heel engagement members may be selectively engageable with the shoe and released by a release mechanism. The release mechanism may be automatically and/or manually activated. When manually activated, it may be activated by either or both of a remote switch and a local activator located on the base.

### FIELD OF THE INVENTION

The invention relates to a platform for use with a bicycle and, in particular, a platform to act as an interface between a shoe and a pedal of the bicycle.

### BACKGROUND

Multidisciplinary sports such as triathlons and biathlons often involve a transition between cycling and running. The equipment for each discipline is designed for efficiencies within that discipline. Running shoes are designed for stress reduction and efficiencies when a competitor's feet contact a hard surface. Cycling shoes on the other hand are designed to efficiently transfer the competitor's effort to the drive train of their bicycle. Modern cycling competitors use so called ‘clipless’ pedals which involve a cleat which creates a mechanical interface with the pedal to prevent unwanted movement of the foot relative to the pedal, thereby allowing more efficient transfer of power to the bicycle by the competitor.

The nature of the different shoe types means that they are entirely unsuited for any other use. Therefore, it is necessary for a competitor in a multidisciplinary sport such as a triathlon to change shoes when changing disciplines. Since the event is judged on the overall completion time, it is generally desirable to reduce the time taken to change disciplines.

### SUMMARY

An embodiment extends to a bicycle platform for releasably attaching a shoe to a pedal of a bicycle, the platform comprising a base having an underside and a topside, the underside being adapted to receive a cleat, the cleat being for engagement with the pedal of the bicycle, the platform further comprising a toe engagement member and a heel engagement member for selectively retaining a shoe in engagement with the platform.

The toe and heel engagement members may be selectively engageable with the shoe and released by a release mechanism. The release mechanism may be automatically and/or manually activated. When manually activated, it may be activated by either or both of a remote switch and a local activator located on the base.

The heel engagement member and the toe engagement member may each be moveable between an engaged position where they retain the shoe in place and a released position where the shoe is releasable from the platform, the platform further comprising a release mechanism for selectively releasing either or both the toe engagement member and the heel engagement member from an engaged position to a released position.

The release mechanism may release both the toe and heel engagement members. The release mechanism may release both the toe and heel engagement members substantially simultaneously.

The release mechanism may comprise a first moveable pin moveable between an engaged position and a retracted position and a first connection member for connecting the first moveable pin to the toe engagement member so that when the first moveable pin is in the engaged position, the connection member retains the toe engagement member in the engaged position.

The release mechanism may comprise a second moveable pin moveable between an engaged position and a retracted position and a second connection member for connecting the second moveable pin to the heel engagement member so that when the second moveable pin is in the engaged position, the second connection member retains the heel engagement member in the engaged position.

The release mechanism may be remotely activated.

The release mechanism may comprise at least one linear actuator connected to the first and/or second moveable pin connected to a servomotor and a control unit where the control unit is adapted to receive a wireless signal and control the servomotor to actuate the linear actuator thereby moving the first and/or second moveable pin to release the heel and/or toe engagement members.

The bicycle platform may comprise a switch remote from the base, the switch being connected to the release mechanism so that activation of the switch causes activation of the release mechanism.

The switch may comprise a first toggle and a second toggle such that the switch is activated when both the first toggle and the second toggle are activated.

The first toggle and the second toggle may be adapted for mounting to a handlebar of the bicycle.

The switch may be wirelessly connected to the release mechanism.

The release mechanism may be manually activated.

The release mechanism may be connected to a lever so that activation of the lever causes manual activation of the release mechanism.

The lever may be located on a side of the base.

The bicycle platform may further comprise a speed sensor for sensing a speed of the bicycle and a control unit for inhibiting the release mechanism when it is determined that the speed of the bicycle exceeds a predetermined speed.

The release mechanism may be both manually activated and automatically activated wherein the control unit inhibits automatic activation of the release mechanism and not manual activation of the release mechanism when it is determined that the speed of the bicycle exceeds a predetermined speed.

The bicycle platform may further comprise a head unit, the head unit being for mounting to the bicycle at a position visible to a user, the head unit comprising a first indicator for indicating when a speed of the bicycle is greater or less than the predetermined speed.

The head unit may comprise a second indicator for indicating when the release mechanism is in the engaged position. In a further embodiment, the bicycle platform may further comprise a head unit, the head unit being for mounting to the bicycle at a position visible to a user, the head unit comprising a first indicator for indicating when the release mechanism is in the engaged position.

A further embodiment extends to a bicycle platform comprising a base having an underside and a topside, the underside being adapted to receive a cleat, the cleat being for engagement with a pedal of a bicycle, the platform further comprising an engagement member for selectively retaining a shoe in engagement with the platform, wherein the engagement member is moveable between an engaged position where the shoe is retained in engagement with the shoe and a released position where the shoe is releasable from the platform, the platform further comprising a release mechanism for moving the engagement member between the engaged position and the released position wherein the release mechanism is remotely activated.

The release mechanism may additionally be manually activated.

The bicycle platform may further comprise a lever for manual activation and a wirelessly controlled powered actuator for remote activation.

Other aspects of the invention will become clearer from the following detailed description of some preferred embodiments thereof.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 is a top perspective view of a bicycle platform according to an embodiment in the engaged position;

FIG. 2 is a left side view of the bicycle platform of FIG. 1;

FIG. 3 is a bottom view of the bicycle platform of FIG. 1;

FIG. 3A illustrates a detail of FIG. 3;

FIG. 4 is a top perspective view of the bicycle platform of FIG. 1 in a released position;

FIG. 5 is a bottom view of the bicycle platform of FIG. 4;

FIG. 6 illustrates a head unit for use with the platform of FIG. 1; and

FIG. 7 illustrates the head unit of FIG. 6 connected to two switches.

### DETAILED DESCRIPTION

The following detailed description is merely exemplary in nature and is not intended to limit the invention or the application and uses of embodiments of the invention. Furthermore, there is no intention to be bound by any theory presented in the preceding background of the invention or the following detailed description.

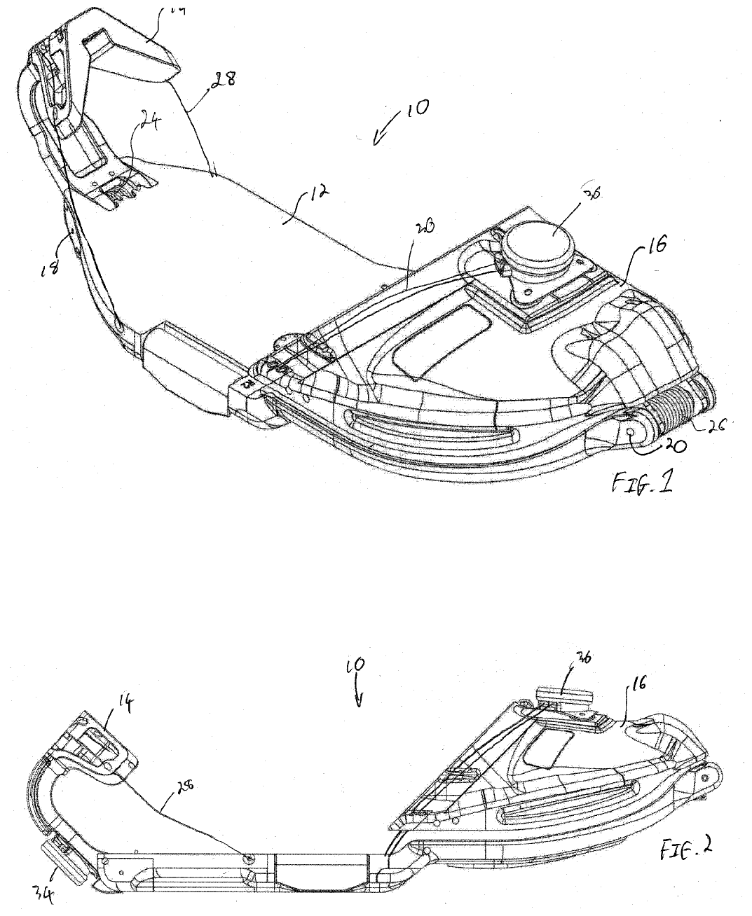

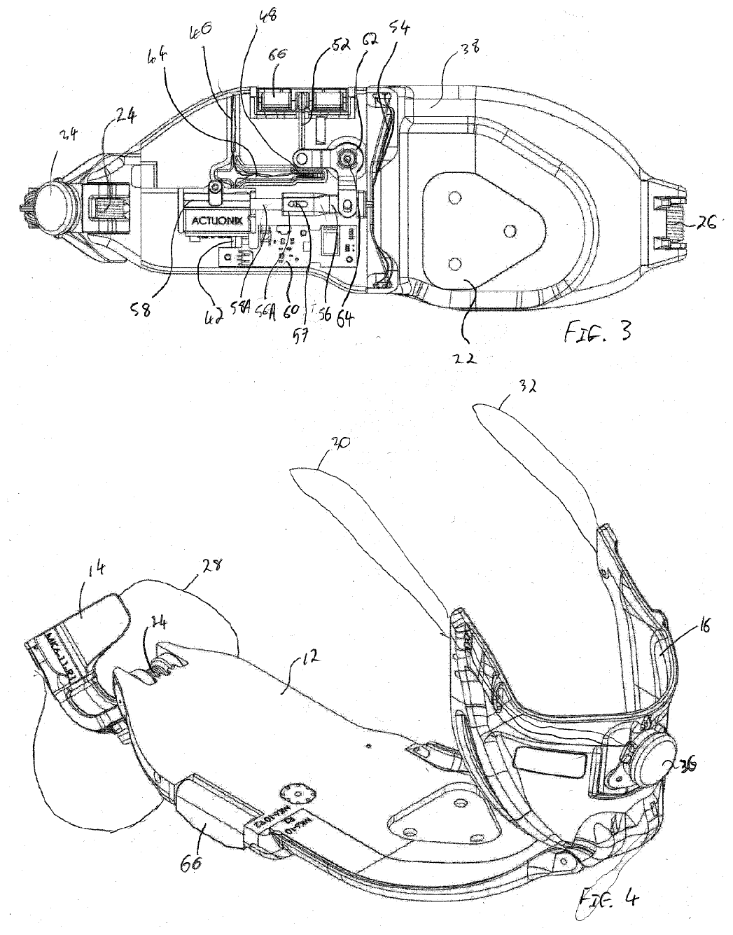

FIG. 1 illustrates a bicycle platform 10 according to an embodiment. The platform 10 includes a base 12 to which a heel engagement member in the form of a heel closure 14 and a toe engagement member in the form of a toe cover 16 are attached. Both the heel closure 14 and the toe cover 16 are attached to the base by respective pins 18 and 20 which allow the heel closure 14 and the toe cover 16 to pivot between engaged positions and released positions.

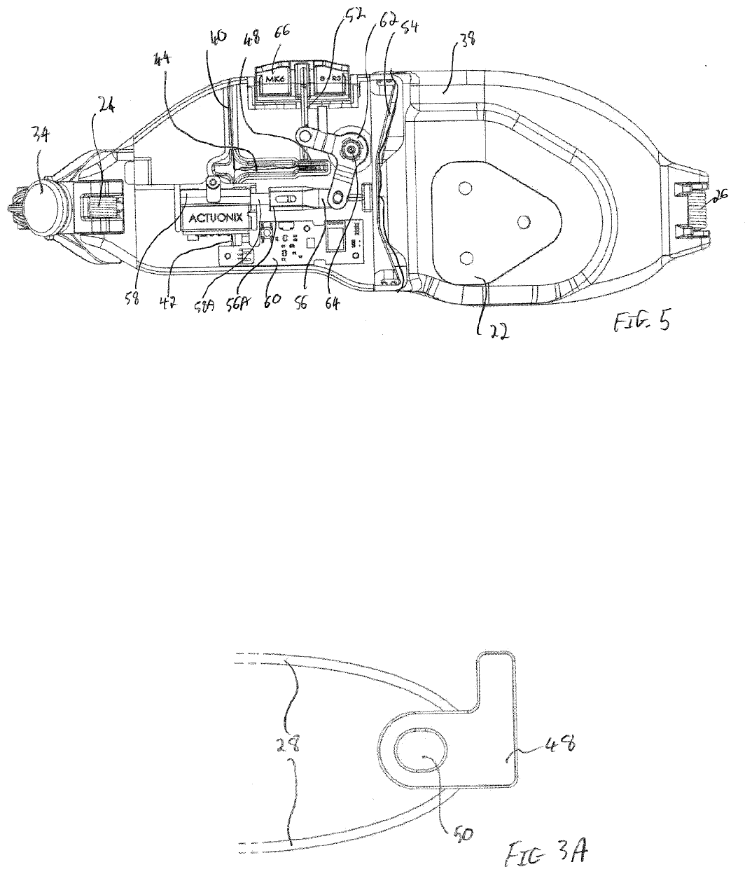

FIG. 1 illustrates the toe cover 16 and heel closure 14 in the engaged position. FIG. 4 illustrates the toe cover 16 and the heel closure in the released position. As can be seen from the accompanying Figures, when the heel closure 14 and the toe cover 16 are in the engaged position (FIG. 1), a shoe may be retained in place on the platform and little, if any, movement of the shoe relative to the platform is permitted. When the toe cover 16 and heel closure 14 are in the released position, a shoe previously kept in engagement with the platform may then be removed.

As illustrated in FIG. 3, the platform 10 includes a mounting plate 22 for mounting a cleat. Such mounting plates are well known in the art, and may be provided with three threaded holes (as shown) or four threaded holes depending on the type of cleats to be mounted. The cleat type will, in turn, depend on the type of bicycle pedal which that cleat is intended to interface with. The cleat and pedal systems are well known in the art.

A competitor in a multidisciplinary sport such as a triathlon is therefore able to use their running shoes with their bicycle. The toe cover 16 and heel closure 14 engage with the running shoe and prevent movement of the shoe relative to the platform 10. The platform 10 engages with a cleat which, in turn, engages with the pedal of the bicycle. So, the platform may provide all of the advantages of the mechanical interface between the cleat and the pedal whilst avoiding the need for a competitor to change shoes. Furthermore, the known cleat and pedal systems are designed to disengage during an accident, a feature which may be retained here.

The mechanism and process whereby a competitor engages and releases their shoe from the platform will now be described.

The platform comprises a spring 24 which acts between the heel closure 14 and the base 12 and which encourages the heel closure 14 towards the released position. Similarly, the platform 10 also includes a spring 26 which encourages the toe covering 16 towards the released position. A heel band 28 retains the heel closure 14 in the engaged position and two toe bands 30 and 32 (see FIG. 4) retain the toe cover 16 in the engaged position. The heel band 28 is connected to a heel tensioner 34 and the toe bands 30 and 32 are connected to a toe tensioner 36. The heel tensioner 34 and toe tensioner 36 act to tighten and loosen the bands. A similar system is sold under the BOA® trade mark.

Turning to FIG. 3, the underside 38 of the base 12 has a number of channels formed therein to route the bands. With respect to the heel band 28, this is routed through two laterally extending channels 40 and 42 (only a portion of channel 42 is visible) and medial channel 44.

As illustrated at FIG. 3A, the heel band 28 is attached to a buckle 48 having a void 50 formed therein. A linkage 52 is mounted in the underside 38 of the base 12 and moves in and out of the medial channel 44. When the linkage 52 has been moved out of the medial channel 44, the buckle may be positioned within the medial channel 44 so that, when the lateral pin 52 is moved back into the medial channel 44, the linkage 52 engages with the void 50 of the buckle 48, thereby anchoring the heel band 28. When the linkage 52 is removed from the void 50, the buckle 48 is free to reciprocate within the medial channel 44 to thereby loosen the heel band 28

Once the heel band 28 has been anchored by engagement of the linkage 52 with the buckle 48, the heel tensioner 34 may be turned to tension the heel band 28. This causes the heel closure 14 to move until it reaches the engaged position shown in FIG. 1.

Although not shown in the accompanying Figures, the base 12 and both the heel closure 14 and toe cover 16 are formed with appropriate stops to prevent movement of the heel closure 14 and the toe cover 16 passed their respective engaged and released positions.

The toe bands 30 and 32 are attached to either side of the toe cover and, with reference to FIG. 3, each toe band is situated on either side of V-shaped lateral channel 54 formed in the underside of the base 12. A driving pin 56 is located on the underside 38 able to move in and out of the V-shaped lateral channel 54. When the loops of the two toe bands 30 and 32 are correctly orientated in the V-shaped lateral channel 54 (when the driving pin has been moved out of the lateral channel 54), then the driving pin may be moved into the lateral channel 54 an engage the two loops, thereby retaining the toe bands 30 and 32 in place. A user is then able to activate the toe tensioner 36 to shorten the effective length of the toe bands 30 and 32 thereby moving the toe cover 16 from the retracted position to the engaged position.

In this manner, a user is able to place their shoe in the platform 10 when the heel closure 14 and toe cover 16 are in the retracted position, anchor the heel band 28 and the toe bands 30 and 32 in place, activate the corresponding heel tensioner 34 and toe tensioner 36, and thereby engage the heel closure 14 with the heel area of the shoe, and cover the toe area of the shoe with the toe cover 16, thereby securely retaining the shoe in place.

It is to be realised that the process of engaging the toe bands 30 and 32 and the heel band 28 involves turning the platform over. For this reason the engagement process may be easier if the shoe is not worn by the user during this process. However, for a sport such as triathlon this is not a disadvantage since competitors progress from swimming to cycling and then running. A competitor will put their shoes on in the process of starting the cycling stage of the race and it may therefore be advantageous for the shoe to be engaged with the bicycle by means of the platform prior to the race commencing.

Since the engagement between the heel closure and the toe cover, and the shoe may be important to ensure efficient use the platform may be made in different sizes to suit different shoe sizes.

The process whereby the shoe is disengaged from the platform 10 is now described.

With reference to FIG. 3, the driving pin 56 is connected to a linear actuator which is controlled by a control unit 60. The control unit 60 is a printed circuit board which, in this embodiment is able to receive Bluetooth signals and, in response thereto, cause the linear actuator to move the driving pin back and forth along the longitudinal axis of the driving pin 56 (heel-to-toe direction). The linear actuator in this embodiment comprises a worm gear connected to a servo motor (not shown in the Figures).

The driving pin 56 is connected to a rocker arm 62 which is able to pivot about pin 64 and which is also connected to the linkage 52. FIG. 3 shows the platform 10 in the engaged orientation. When the driving pin 56 moves in the heel direction, this causes the rocker arm 62 to move from the orientation shown in FIG. 3 to the orientation shown in FIG. 5. This causes the driving pin 56 to move out of the V-shaped lateral groove 54 and the linkage 52 to move out of the medial groove 44. This, in turn causes the release of the heel band 28 and the toe bands 30 and 32.

Once the heel band 28 and toe bands 30 and 32 have been released, the heel closure 14 and toe cover 16 are free to move and their respective springs 24 and 26 will move them into their retracted positions.

A manual release is also provided. A handle 66 is mounted on the side of the base 12 and is able to pivot between the positions shown in FIGS. 3 and 5. The handle 66 is connected to the linkage 52 so that moving the handle and pivoting it up (i.e. in the direction towards the topside of the base 12) causes the linkage 52 to move out of the medial groove 44, thereby releasing the heel band 28. As the linkage 52 moves out of the medial groove 44, this causes pivoting of the rocker arm 62 which, in turn, causes movement of the driving pin 56 in the toe direction causing the driving pin 56 to move out of the V-shaped lateral groove 54 thereby releasing the toe bands 30 and 32.

The driving pin 56 has a sleeve 56A within which a shaft 58A of the linear actuator 58 is received. A pin and slot arrangement 57 allows sleeve 56A to reciprocate independently of the shaft 58A when the driving pin is moved by activation of the handle 66, thereby avoiding unnecessary movement of the linear actuator 58 which may damage components thereof. A spring (not shown) allows the return of the driving pin 56 to the position shown in FIG. 3.

In this manner, the handle 66 provides a manual release providing the user with a way of overriding the automatic release or of securing a release of their shoe if the automatic release fails.

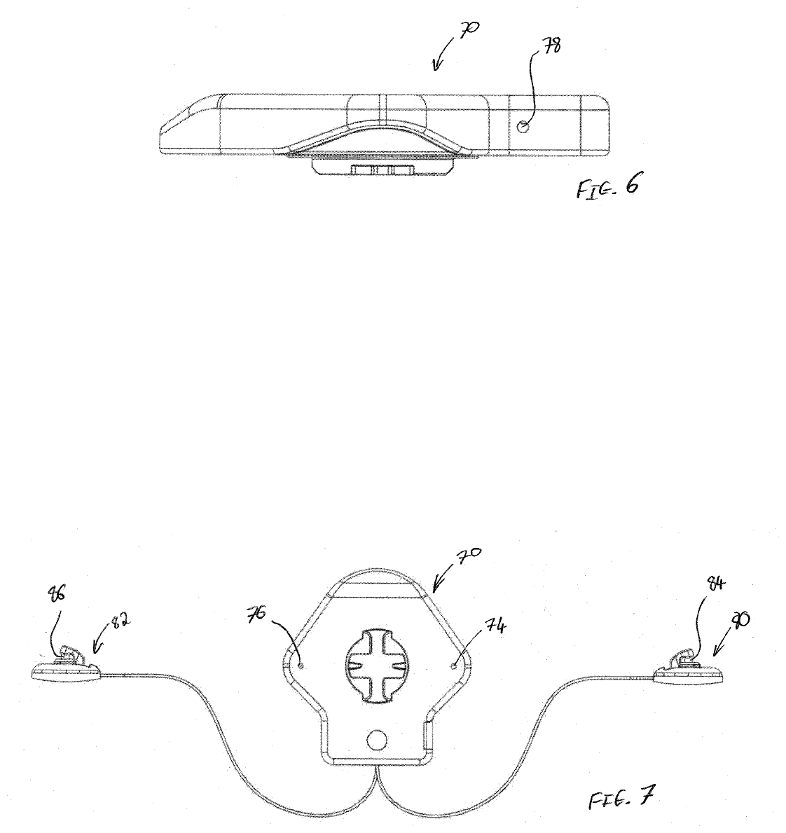

FIG. 6 illustrates a head unit 70 and FIG. 7 illustrates the head unit connected to two switches 80 and 82. The head unit is adapted to be mounted to the stem or handlebars of a user's bicycle and includes a socket 72 for mounting a cycling computer to the head unit 70. The head unit further comprises three indicator LED lights 74, 76 and 78 which are used to communicate with the user in the manner described. Two switches 80 and 82 having toggles 84 and 86 are connected to the head unit 70. As shown, the switches 80 and 82 are shaped to fit the handlebars of a user's bicycle.

The head unit 70, communicates with the control unit 60 of the platform 10 via Bluetooth. When a user depresses both toggles 84 and 86 on the switches 80 and 82, the head unit sends a signal to the control unit 60 which causes the control unit 60 to release the heel closure 14 and toe cover 16.

It has been found that using two switches may be preferable to using a single switch as it may reduce the incidence of unintended release. With two switches, the head unit may only send the release signal to the control unit when the toggles of both switches are depressed.

The status light 76 is used to indicate to the user that the system (i.e. the platform and head unit) is operational and that the head unit 70 is in wireless communication with the control units 60 of both platforms, left and right which are not reporting any errors. The status light 74 is used to communicate to the user that the release has been activated. When the user depresses both the toggles 84 and 86 on the switches 80 and 82 and the head unit 70 has sent the release signal to the control unit, the head unit will light the status light 74. The user will then be alerted that a release is imminent. If the release does not then occur, the user may use the handle 66 to secure a manual release. Status light 78 has the same function as status light 76 and, since it is visible from the side, may be beneficial to technicians when setting up the platform on a user's bicycle.

In an alternative embodiment, the switches 80 and 82 may also communicate wirelessly with the head unit 70.

Although not shown in the accompanying Figures, the head unit includes an accelerometer which allows the head unit to activate when the bicycle is moved, avoiding the need to keep the unit in an active state when not used which may unnecessarily deplete the battery (also not shown). Furthermore, such an arrangement may also prevent the need for the user to take a specific action to activate the head unit which could distract the user.

In a yet further embodiment, the head unit comprises a speed sensor which may, for example, be in the form of a GPS unit and the head unit is configured to avoid sending the release signal to the control unit 60 if the speed exceeds a predetermined value (e.g. 5 km/h). This may avoid inadvertent release of the user's shoes.

It is to be realised that although a platform suitable for a left shoe has been illustrated and described, in use a second platform, being the mirror image of the one shown, will be used for the right shoe. The right shoe platform operates in all material respects in the same manner as the left shoe platform. The head unit 70 will, in use, communicate with both platforms and cause both platforms to release their respective shoes when the switches are activated. If manual release is desired, the handle of each platform may be engaged by the user.

1. A bicycle platform for releasably attaching a shoe to a pedal of a bicycle, the platform comprising a base having an underside and a topside, the underside being adapted to receive a cleat, the cleat being for engagement with the pedal of the bicycle, the platform further comprising a toe engagement member and a heel engagement member for selectively retaining a shoe in engagement with the platform.

2. The bicycle platform according to claim 1 wherein the heel engagement member and the toe engagement member are each moveable between an engaged position where they retain the shoe in place and a released position where the shoe is releasable from the platform, the platform further comprising a release mechanism for selectively releasing either or both the toe engagement member and the heel engagement member from an engaged position to a released position.

3. The bicycle platform according to claim 2 wherein the release mechanism comprises a first moveable pin moveable between an engaged position and a retracted position and a first connection member for connecting the first moveable pin to the toe engagement member so that when the first moveable pin is in the engaged position, the connection member retains the toe engagement member in the engaged position.

4. The bicycle platform according to claim 2 wherein the release mechanism comprises a second moveable pin moveable between an engaged position and a retracted position and a second connection member for connecting the second moveable pin to the heel engagement member so that when the second moveable pin is in the engaged position, the second connection member retains the heel engagement member in the engaged position.

5. The bicycle platform according claim 2 wherein the release mechanism is remotely activated.

6. The bicycle platform according to claim 5 comprising a switch remote from the base, the switch being connected to the release mechanism so that activation of the switch causes activation of the release mechanism.

7. The bicycle platform according to claim 6 wherein the switch comprises a first toggle and a second toggle and wherein the switch is activated when both the first toggle and the second toggle are activated.

8. The bicycle platform according to claim 7 wherein the first toggle and the second toggle are adapted to mount to a handlebar of the bicycle.

9. The bicycle platform according to claim 6 wherein the switch is wirelessly connected to the release mechanism.

10. The bicycle platform according to claim 2 wherein the release mechanism is adapted for manual activation.

11. The bicycle platform according to claim 10 wherein the release mechanism is connected to a lever so that activation of the lever causes manual activation of the release mechanism.

12. The bicycle platform according to claim 11 wherein the lever is located on a side of the base.

13. The bicycle platform according to claim 2 further comprising a speed sensor for sensing a speed of the bicycle and a control unit for inhibiting the release mechanism when it is determined that the speed of the bicycle exceeds a predetermined speed.

14. The bicycle platform according to claim 13 wherein the release mechanism is both manually activated and automatically activated and wherein the control unit inhibits automatic activation of the release mechanism and does not inhibit manual activation of the release mechanism when it is determined that the speed of the bicycle exceeds a predetermined speed.

15. The bicycle platform according to claim 13 further comprising a head unit, the head unit being for mounting to the bicycle at a position visible to a user, the head unit comprising a first indicator for indicating when a speed of the bicycle is greater or less than the predetermined speed.

16. The bicycle platform according to claim 15 wherein the head unit comprises a second indicator for indicating when the release mechanism is in the engaged position.

17. A bicycle platform comprising a base having an underside and a topside, the underside being adapted to receive a cleat, the cleat being for engagement with a pedal of a bicycle, the platform further comprising an engagement member for selectively retaining a shoe in engagement with the platform, wherein the engagement member is moveable between an engaged position where the shoe is retained in engagement with the shoe and a released position where the shoe is releasable from the platform, the platform further comprising a release mechanism for moving the engagement member between the engaged position and the released position wherein the release mechanism is remotely activated.

18. The bicycle platform according to claim 17 wherein the release mechanism is additional manually activated.

19. The bicycle platform according to claim 18 comprising a lever for manual activation and a wirelessly controlled powered actuator for remote activation.
